(19) United States
(12) Patent Application Publication
(10) Pub. No.: US 2020/0061778 A1
(43) Pub. Date: Feb. 27, 2020

(54) Adjustable Pliers

(71) Applicant: Snap-on Incorporated, Kenosha, WI (US)

(72) Inventors: David T. Doyle, Kenosha, WI (US); Jason A. Frey, Pleasant Prairie, WI (US); Anup A. Gupte, Buffalo Grove, IL (US)

(73) Assignee: Snap-on Incorporated, Kenosha, WI (US)

(21) Appl. No.: 16/106,361

(22) Filed: Aug. 21, 2018

(51) Int. Cl. B25B 7/10; B25B 7/14

(52) U.S. Cl. CPC B25B 7/10; B25B 7/14

(57) ABSTRACT

Disclosed are adjustable pliers where the pawl mechanism can be engaged or disengaged to adjust a jaw gap of the pliers. The pawl mechanism can be disengaged either by rotating the handles so as to cause a tab to engage a pocket, and/or by lifting upward on the handles to disengage the pawl teeth from corresponding teeth in a slot of one of the handles. The pliers are therefore advantageous because they do not require a button or lever to adjust the jaw gap, and can therefore be adjusted easily.

### TECHNICAL FIELD OF THE INVENTION

The presently invention relates generally to pliers. More particularly, the present invention relates to pliers that are adjustable with a force exerted on a pawl mechanism of the pliers.

### BACKGROUND OF THE INVENTION

Pliers are a common hand tool used to grab hold of many different types of work pieces (e.g., bolts, nuts, pipes, etc.). Pliers typically include two handles, each having a jaw that is rotatable about a pin that couples the two handles together. The jaws grip a work piece and the handles are used for leverage and grip to apply a force to the work piece. For example, the pliers can then be rotated to insert or remove a threaded work piece, or pulled axially outward so as to remove an unthreaded work piece such as a nail.

Many pliers are adjustable at the coupling pin. For example, one of the handles may include a slot and the pin can be inserted through the slot and be movable therein. When the pin is located lower in the slot, for example, the distance between the jaws is larger and the pliers can be used for larger work pieces, and when the pin is higher in the slot, the distance between the jaws is smaller and the pliers can be used for smaller work pieces. A pawl can engage corresponding teeth in the pliers' handle to maintain the pawl's position within the slot, and a button or lever can be used to remove the pawl from the teeth and allow adjustment of the pliers.

### SUMMARY OF THE INVENTION

The present invention broadly comprises pliers that are adjustable by exerting a force on a pawl mechanism of the pliers. For example, the pliers can be adjusted by rotating the handles outwardly to cause a tab within the pawl mechanism to engage a pocket within one of the handles, thereby disengaging the pawl mechanism and allowing adjustment of the handles. In some embodiments, the pliers can disengage by lifting upwardly on one handle and removing the pawl from the corresponding teeth. In this manner, the pliers do not require a button or lever to adjust the jaw gap, and can therefore be adjusted.

For example, embodiments of the present invention broadly comprise pliers including a first handle, a second handle having a slot defined therein and including slot teeth, a link coupling the first and second handles together and allowing rotation of the first and second handles about the link, and a pawl mechanism coupled to the link and including pawl teeth engaging the slot teeth. The pawl mechanism further includes a roller and a tab rotating about the roller. At least one of the first and second handles includes a pocket receiving the tab to cause disengagement of the pawl teeth with respect to the slot teeth.

Embodiments of the present invention further broadly comprise pliers including a first handle, a second handle having a slot defined therein and including slot teeth, and a link coupling the first and second handles together and allowing rotation of the first and second handles with respect to the link, and a pawl mechanism coupled to the link and including pawl teeth engaging the slot teeth. The pawl mechanism further includes a roller and a tab rotating about the roller. At least one of the first and second handles includes a pocket receiving the tab to cause disengagement of the pawl teeth with respect to the slot teeth. The pawl teeth are removable from the slot teeth by a force applied to the pawl mechanism perpendicular to a direction in which the slot extends.

Further embodiments of the present invention broadly comprise pliers including a first handle, a second handle having a slot defined therein and including slot teeth, a link coupling the first and second handles together and allowing rotation of the first and second handles with respect to the link, and a pawl mechanism coupled to the link and including pawl teeth engaging the slot teeth. The pawl teeth are removable from the slot teeth by a force applied to the pawl mechanism perpendicular to a direction in which the slot extends.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a top perspective exploded, disassembled view of pliers according to at least some of the presently disclosed embodiments.

FIG. 2A is a front view of pliers showing the tab beginning to engage the pocket according to at least some of the presently disclosed embodiments.

FIG. 2B is an enlarged partial view of pliers from the view labeled 2B in FIG. 2A according to at least some of the presently disclosed embodiments.

FIG. 3A is a front view of pliers showing the tab more fully engaging the pocket and disengaging the pawl from the slot teeth according to at least some of the presently disclosed embodiments.

FIG. 3B is an enlarged partial view of pliers from the view labeled 3B in FIG. 3A according to at least some of the presently disclosed embodiments.

FIG. 4 is a front view of pliers according to at least some of the presently disclosed embodiments.

FIG. 5A is a front view of pliers showing the pawl mechanism being lifted from the slot teeth according to at least some of the presently disclosed embodiments.

FIG. 5B is an enlarged partial view of pliers from the view labeled 5B in FIG. 5A according to at least some of the presently disclosed embodiments.

FIG. 6 is a side perspective view of a pawl mechanism showing the pawl teeth engaged with the slot teeth according to at least some of the presently disclosed embodiments.

FIG. 7 is a side perspective view of a pawl mechanism showing the pawl teeth disengaged with the slot teeth according to at least some of the presently disclosed embodiments.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention broadly comprises adjustable pliers where a pawl mechanism can be selectively engaged or disengaged to adjust a jaw gap of the pliers. For example, the pawl mechanism can be disengaged from the handles with a tab and pocket mechanism. In this embodiment, at least one of the handles can be rotated outwardly to cause a tab within the pawl mechanism to engage a pocket within one of the handles, thereby selectively disengaging the pawl mechanism and allowing adjustment of the handles. In addition to the above or as an alternative to the above, the pawl mechanism can be disengaged by lifting upwardly on one handle to remove the pawl from the corresponding teeth in the slot. The pliers are therefore advantageous because they do not require a button or lever to adjust the jaw gap, and can therefore be adjusted.

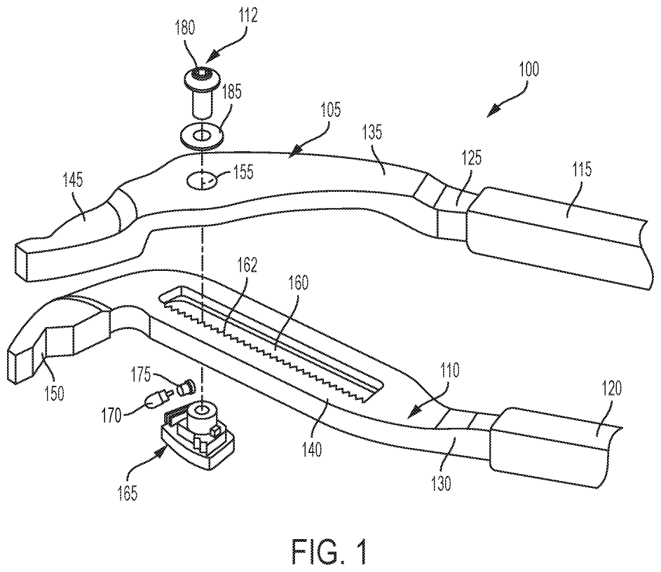

As shown in FIG. 1, pliers 100 can include first 105 and second 110 handles coupled together and rotatable about a link 112. The first 105 and second 110 handles can respectively include first 115 and second 120 grips that a user can grip while using the pliers 100, and first 125 and second 130 transition points extending from the grips 115, 120 and coupling to first 135 and second 140 bases. First 145 and second 150 jaws can respectively extend from the first 135 and second 140 bases and act as working ends of the pliers to grip work pieces and apply torque or axial force to the work pieces.

The link 112 can be inserted through a hole 155 in the first handle 105 and through a slot 160 in the second handle 110. The slot 160 can include teeth 162 that engage corresponding teeth of a pawl mechanism 165, as discussed below in more detail. For example, a pin 170 and elastic member 175 can bias the pawl mechanism 165 into engagement with the teeth 162 and provide a tactile indication when the user adjusts the pawl mechanism 165 to a different position that increases or decreases the jaw gap (i.e., the maximum usable distance between the jaws when opened). The link 112 can be coupled to the pawl mechanism 165 by a fastener 180 and washer 185.

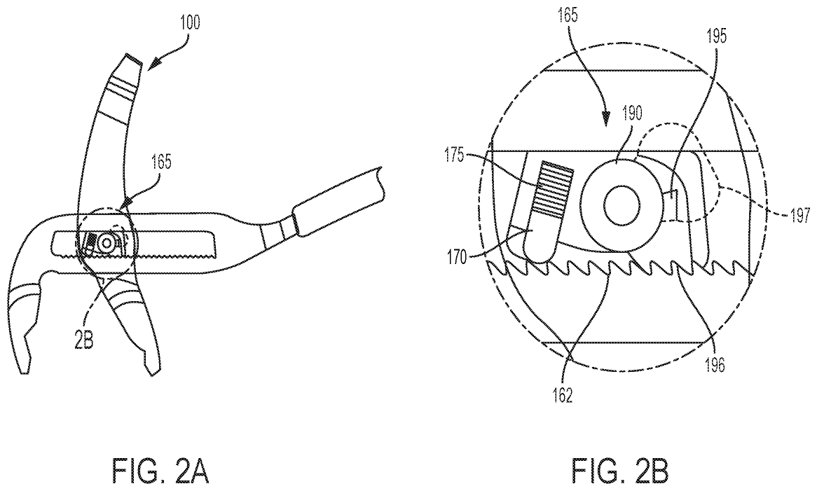

Referring also to FIGS. 2A and 2B, the pliers 100 can include a pawl mechanism 165 that engages slot teeth 162 when in a desired position. The pawl mechanism 165 can include a roller 190 that acts as a rotational base of the pawl mechanism 165, and a tab 195 coupled to the roller 190. The pawl mechanism 165 can further include pawl teeth 196 that couple to slot teeth 162 to maintain the desired position.

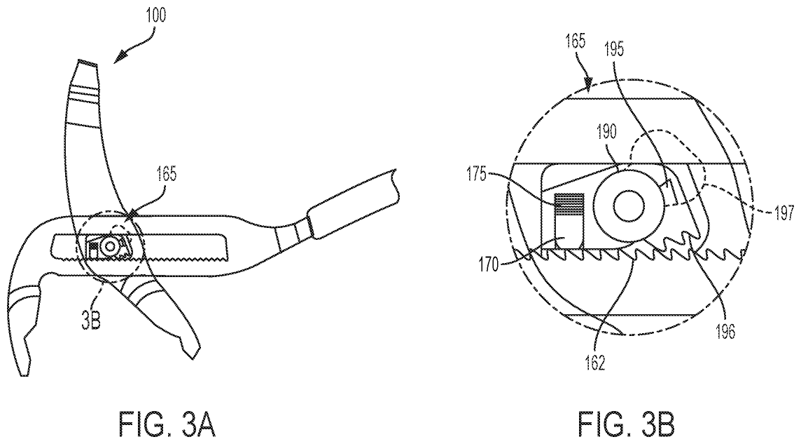

When the user wishes to adjust the jaw gap of the pliers 100, the user can open the handles 105, 110 of the pliers 100 to cause the tab 195 to engage a pocket 197 of the first 105 or second 110 handles to disengage the pawl mechanism 165 from the slot teeth 162. For example, as shown in FIG. 2B, rotation of the first 105 or second 110 handles causes the tab 195 to abut against the pocket 197, and as shown in FIGS. 3A and 3B; further rotation of the handles 105, 110 causes the tab 195 to push further against the pocket 197 to provide a force to overcome the bias force of the elastic member 175. In doing so, rotation of the handles 105, 110 causes the tab 195 to engage the pocket 197 and push the pawl teeth 196 outwardly to disengage the pawl mechanism 165 from the slot teeth 162. The user can then adjust the location of the first handle 105 with respect to the second handle 110 to increase or decrease the jaw gap (i.e., the gap between the two jaws 145, 150 as determined by the relative location of the first handle 105 and the second handle 110). In doing so, the user can adjust the jaw gap to fit differently sized work pieces without pushing a button or a lever on the pliers 100.

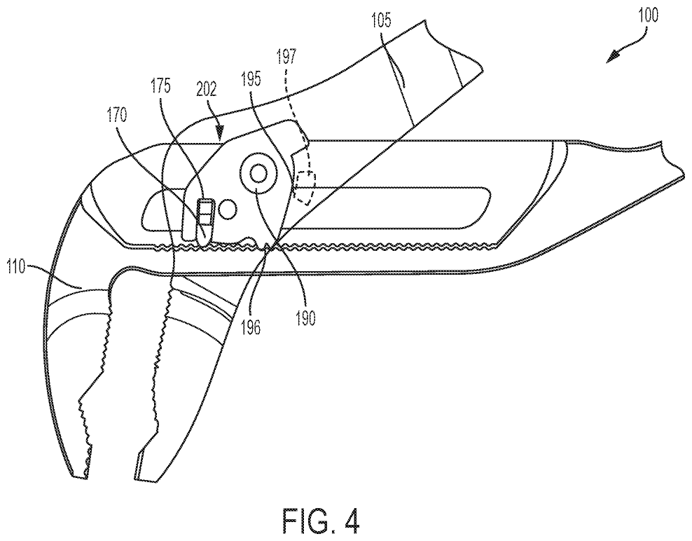

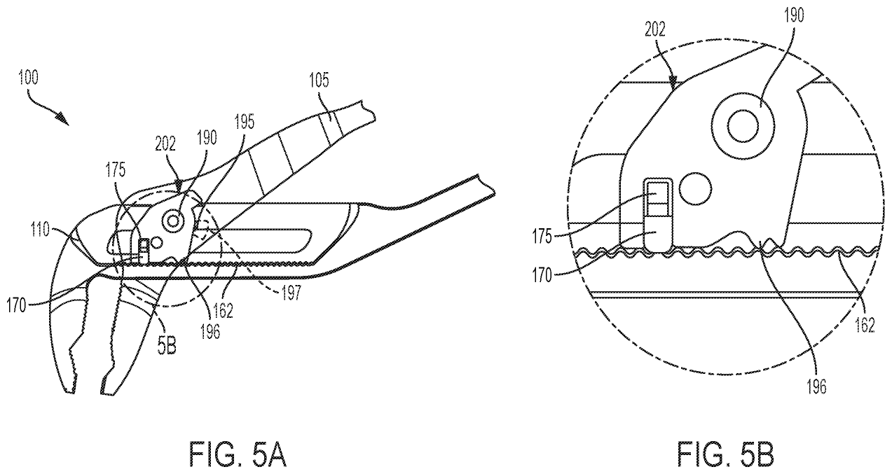

Referring also to FIGS. 4, 5A and 5B, in an embodiment, the pliers 100 can include a hybrid pawl mechanism 202 that can disengage pawl teeth 196 from the slot teeth 162 to allow adjustment of the jaw gap. As shown, the hybrid pawl mechanism 202 disengages by either rotating the first 105 or second 110 handles to cause the tab 195 to engage the pocket 197, as discussed above, or by merely pulling upwardly on the hybrid pawl mechanism 202 to remove the pawl teeth 196 from the slot teeth 162.

For example, FIG. 5B illustrates one manner in which the hybrid pawl mechanism 202 can be pulled upward to disengage the pawl teeth 196 from the slot teeth 162. As shown, the link 112 of the hybrid pawl mechanism 202 can be movable in an upward direction within a slot, against the bias of the elastic member 175, to remove the hybrid pawl mechanism 202 from the slot teeth 162 and allow adjustment of the hybrid pawl mechanism 202. Alternatively, or in addition to the above, the hybrid pawl mechanism 202 can be disengaged by rotation of one or both of the first 105 or second 110 handles to cause a tab 195 to engage a pocket 197, as discussed above in more detail.

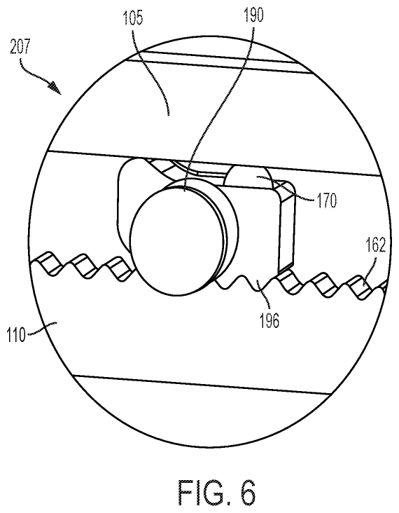

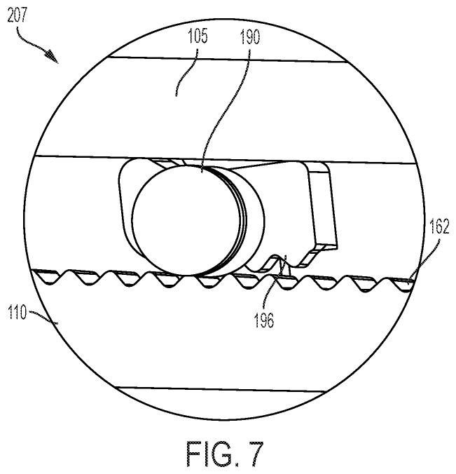

FIG. 6 is a side perspective view of a lift release pawl mechanism 207 showing the pawl teeth 196 engaged with the slot teeth 162; and FIG. 7 is a side perspective view of the lift release pawl mechanism 207 showing the pawl teeth 196 disengaged with the slot teeth 162, according to at least some of the presently disclosed embodiments. Similar to FIGS. 1-5B, the pin 170 can be elastically biased by the elastic member 175 located within the lift release pawl mechanism 207. As shown, FIGS. 6 and 7 illustrate the lift release pawl mechanism 207 that allows adjustment of the jaw gap by pulling upwardly on the first 105 or second 110 handle. For example, to adjust a jaw gap, the user can hold the second handle 110 and pull upwardly on the first handle 105 against the bias force of the elastic member 175. The upwardly applied force can be applied to the first handle 105 perpendicular to the direction in which the slot 160 extends to disengage the pawl teeth 196 from the slot teeth 162, as shown in FIG. 7. Thereafter, the user can adjust the location of the first handle 105 with respect to the second handle 110 to thereby adjust the jaw gap.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. Pliers having a first handle and a second handle with a slot defined therein, comprising:
slot teeth disposed in the slot;
a link coupling the first and second handles together and allowing rotation of the first and second handles relative to each other about the link; and
a pawl mechanism coupled to the link and including pawl teeth engaging the slot teeth, the pawl mechanism including a roller and a tab rotating about the roller,
wherein at least one of the first and second handles includes a pocket receiving the tab to cause disengagement of the pawl teeth with respect to the slot teeth.

2. The pliers of claim 1, further comprising an elastic member biasing the pawl teeth into engagement with the slot teeth.

3. The pliers of claim 2, wherein the elastic member applies a bias force to the tab to bias the tab into engagement with the pocket, and wherein rotation of the roller overcomes the bias of the elastic member to disengage the pawl teeth from the slot teeth.

4. The pliers of claim 1, wherein the first handle includes a hole that the link inserts into to couple the first handle to the second handle.

5. The pliers of claim 1, further comprising a pin coupled to the elastic member and, cooperatively with the elastic member, biases the pawl teeth into engagement with the slot teeth.

6. The pliers of claim 1, wherein the link includes a fastener and a washer.

7. The pliers of claim 1, wherein the pawl teeth are removable from the slot teeth by a force perpendicular to a direction in which the slot extends.

8. Pliers comprising:
a first handle;
a second handle having a slot defined therein, the slot including slot teeth;
a link coupling the first and second handles together and allowing rotation of the first and second handles with respect to the link; and
a pawl mechanism coupled to the link and including pawl teeth engaging the slot teeth, the pawl mechanism further comprising a roller and a tab rotating about the roller,
wherein at least one of the first and second handles includes a pocket receiving the tab to cause disengagement of the pawl teeth with respect to the slot teeth; and
wherein the pawl teeth are removable from the slot teeth by a force applied to the pawl mechanism perpendicular to a direction in which the slot extends.

9. The pliers of claim 8, further comprising an elastic member biasing the pawl teeth into engagement with the slot teeth.

10. The pliers of claim 9, wherein the elastic member applies a bias to the tab to bias the tab into engagement with the pocket, and wherein rotation of the roller overcomes the bias of the elastic member to disengage the pawl teeth from the slot teeth.

11. The pliers of claim 8, wherein the first handle includes a hole that the link inserts into to couple the first handle to the second handle.

12. The pliers of claim 8, further comprising a pin coupled to the elastic member and, together with the elastic member, biasing the pawl teeth against the slot teeth.

13. The pliers of claim 8, wherein the link includes a fastener and a washer.

14. Pliers comprising:
a first handle;
a second handle having a slot defined therein, the slot including slot teeth;
a link coupling the first and second handles together and allowing rotation of the first and second handles with respect to the link; and
a pawl mechanism coupled to the link and including pawl teeth engaging the slot teeth,
wherein the pawl teeth are removable from the slot teeth by a force applied to the pawl mechanism perpendicular to a direction in which the slot extends.

15. The pliers of claim 14, wherein the pawl mechanism further comprises a roller and a tab rotating about the roller, wherein at least one of the first and second handles includes a pocket receiving the tab to cause disengagement of the pawl teeth with respect to the slot teeth.

16. The pliers of claim 15, further comprising an elastic member biasing the pawl teeth into engagement with the slot teeth.

17. The pliers of claim 15, wherein the elastic member applies a bias to the tab to bias the tab into engagement with the pocket, and wherein rotation of the roller overcomes the bias of the elastic member to disengage the pawl teeth from the slot teeth.

18. The pliers of claim 14, wherein the first handle includes a hole that the link inserts into to couple the first handle to the second handle.

19. The pliers of claim 14, further comprising a pin coupled to the elastic member and, together with the elastic member, biasing the pawl teeth against the slot teeth.

20. The pliers of claim 14, wherein the link includes a fastener and a washer.
